(19) United States
(12) Patent Application Publication
(10) Pub. No.: US 2007/0153456 A1
(43) Pub. Date: Jul. 5, 2007

(54) Portable electronic device capable of inserting display monitor into housing

(75) Inventor: Yung-Kun Lin, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/500,900

(22) Filed: Aug. 9, 2006

(30) Foreign Application Priority Data
Dec. 23, 2005 (TW) 094146188

(51) Int. Cl. G06F 1/16

(52) U.S. Cl. 361/681

(57) ABSTRACT

An electronic device includes a housing. The housing includes a cavity for inserting a display monitor and a support module. When the display monitor is extended outside the housing, the support module is moves along the track while coupled to the track for loading the display monitor. When the display monitor is fully extended, the support module then rotates with a specific angle forming an open position to allow the display monitor to be viewed uncovered outside the housing. The display monitor can also be lodged within the housing to protect the monitor surface and to utilize electricity saving features.

### BACKGROUND OF THE INVENTION

1. Field of the Invention

This invention relates to an electronic device, and more particularly, to an electronic device with a sliding display monitor from its housing. When using the sliding display module, a user can pull the sliding display monitor out of the housing to a specific opening angle.

2. Description of the Prior Art

In our modern society with advanced developments in communication systems, handheld electronic devices are widely used in everyday life. Wireless communication devices (e.g. cellular phones), for example, provide a means for communication while offering the benefit of convenience and portability. People can exchange information, ideas, and personal experiences through the use of various portable electronic devices. Portable electronic products are constantly improving as trends in popularity and technology continue. Therefore, it is critical that designers continue to improve relevant electronic portable products so that they appear more functional and accessible.

Currently, many types handheld electronic devices (e.g. cell phones or personal digital assistants) contain display monitors (e.g. liquid crystal display (LCD) monitors) that are externally placed outside its housing. With this configuration, the surface of the display monitor is continually exposed due to its uncovered surface, potentially causing scrape/damage and inconvenience for users. The display monitors for some current handheld electronic devices have a significant portion of its housing covered, forcing the user interface of user command input module (e.g. keyboard) to be reduced in size in order to be adapted to the size of the display monitor. In this type of configuration, users may have difficulties in touching or operating the user interface when using such an electronics device. Moreover, since the display monitors of some portable electronic devices are on the same surface as the user command input modules (e.g. keyboard), it may cause an un-ideal viewing angle for the display module. Users viewing the display monitor may experience some operational difficulties when operating the user command input module due to under-optimization of the display monitor angle.

### SUMMARY OF THE INVENTION

It is therefore one of the many objectives of the claimed invention, to provide an electronic device with a sliding display monitor extending from inside its housing to solve the above-mentioned problems.

According to an embodiment of the present invention, an electronic device is disclosed. An electronic device includes a housing. The housing includes a cavity for inserting a display monitor and a support module. When the display monitor is extended outside the housing, the support module moves along the track while coupled to the track for loading the display monitor. When the display monitor is fully extended, the support module then rotates with a specific angle forming an open position to allow the display monitor to be viewed uncovered outside the housing. The display monitor can also be lodged within the housing to protect the monitor surface and to utilize electricity saving features.

The display monitor of the present invention can move on a track by means of a support module, and can be lodged into the housing when not in use to protect the monitor surface. The power for the display monitor can be shut down while lodged into the housing. A supplemental display monitor can be further provided as an operational interface displaying affiliated functions (e.g. caller display, music media display, or digital camera) of the electronics device to thereby reduce power consumption. Additionally, because the main display monitor is not located on the external surface of the housing, the usable area for a user command input module (e.g. keyboard) is increased. Furthermore, inconveniences from conventional electronic devices (e.g. cellular phone) caused by poor viewing angles can be solved by adjusting the display angle of the display monitor in the electronic device of the present invention. Overall convenience, and flexibility in ergonomic design for an operational interface is therefore greatly improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display monitor of an electronic device in a closed position according to a first embodiment of the present invention.

FIG. 2 is a diagram illustrating the display monitor in an operating mode according to the electronic device as shown in FIG. 1.

FIG. 3 is an assembly diagram illustrating various components of the electronic device as shown in FIG. 1.

FIG. 4 is a cross-sectional view of the electronic device as shown in FIG. 1.

FIG. 5 is a cross-sectional view of the electronic device as shown in FIG. 2.

FIG. 6 is a cross-sectional view of a display monitor of an electronic device in a closed position according to a second embodiment of the present invention.

FIG. 7 is a cross-sectional diagram illustrating the display monitor in an operating mode according to the electronics device as shown in FIG. 6.

FIG. 8 is an assembly diagram illustrating components of the electronic device as shown in FIG. 6.

FIG. 9 is an assembly diagram illustrating components of the support module as shown in FIG. 6.

### DETAILED DESCRIPTION

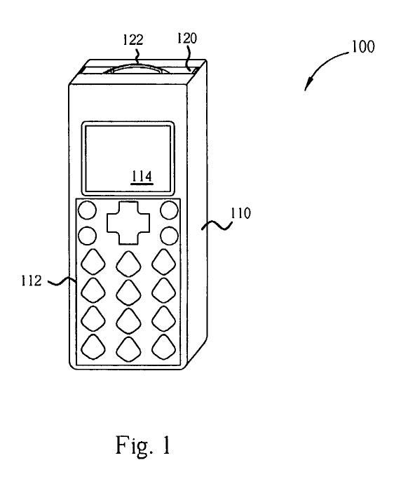

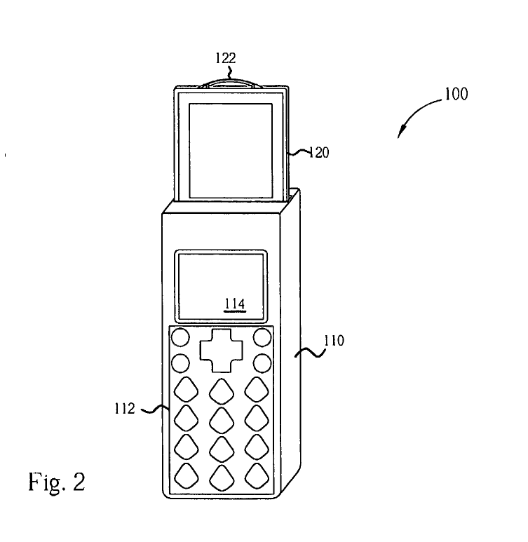

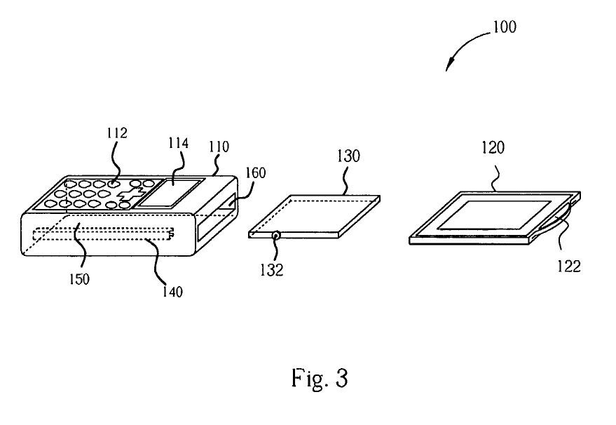

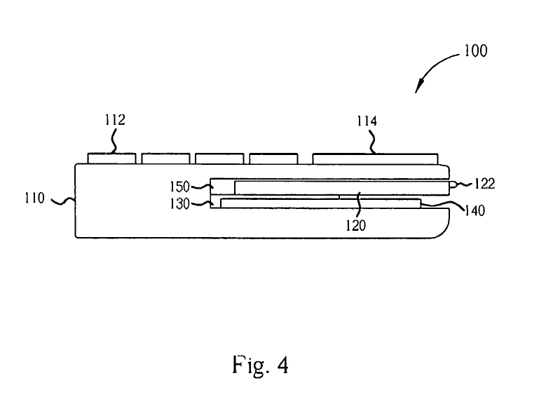

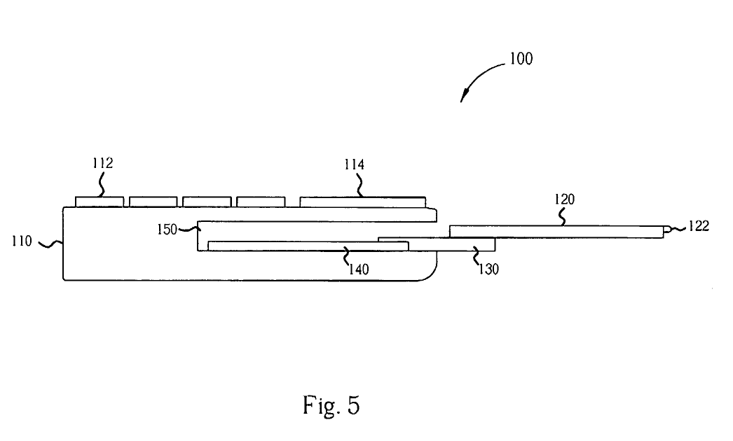

The following description draws reference from FIG. 1 to FIG. 5. FIG. 1 illustrates a display monitor 120 of an electronic device 100 in a closed position according to a first embodiment of the present invention. FIG. 2 is a diagram illustrating the display monitor 120 in an open position (for operating mode) according to the electronic device 100 shown in FIG. 1. FIG. 3 is an assembly diagram illustrating the various components of the electronic device 100 as shown in FIG. 1. FIG. 4 is a cross-sectional view of the electronic device 100 as shown in FIG. 1, and FIG. 5 is a cross-sectional view of the electronic device 100 as shown in FIG. 2.

In the preferred embodiment, the electronic device 100 is a portable electronic device. For example, it can include a cellular phone, a personal digital assistant (PDA), and so forth. The electronic device 100 includes a housing 110, a display monitor 120 (e.g. a liquid crystal display (LCD) monitor), and a support module 130. As shown in FIG. 3, the display monitor 120, which is the main display monitor of the electronic device 100, displays a user interface of the electronic device 100. The display monitor 120 includes a ring handle 122 for users to easily pull the display monitor 120 out of the housing 110 for viewing.

An opening 160 is located on the top surface of the housing 110, while the housing 110 further includes a cavity 150 providing the required space for accommodating the display monitor 120 while in a closed position. In addition, at least a track 140 is located inside the housing 110 for providing an axis for sliding, and for placement of the support module 130. In this preferred embodiment, the support module 130 having a first portion can slide while coupled to the track 140, and carries the display monitor 120. The support module 130 having a second portion can move along the track 140, and is able to insert the display monitor 120 within the cavity 150, or conversely can extend the display monitor 120 outside of the housing 110 through the opening 160.

Please note that, in this preferred embodiment, other auxiliary support devices or said second portion (e.g. a pulley 132 or a gear mechanism) can also be incorporated into the support module 130 to improve a sliding function for the support module 130 on the track 140. However, the support module 130 is not limited to being configured with a pulley 132. In other embodiments, a support module 130 without a pulley is adaptable and still belongs to the scope of the present invention therein. Moreover, only one track 140 is shown in FIG. 3, with the support module 130 showing only one pulley 132 on one side. However, in other embodiments, the housing 110 can include multiple tracks on both sides, and the support module 130 can also include multiple pulleys on both sides to help stabilize the sliding movement. In other words, the present invention is not limited to the number of tracks or pulleys presented. Additionally, the shapes, structure, and locations of the track 140 and pulley 132 shown in FIG. 3 are shown only for exemplary purposes and should not be regarded as limitations for the present invention.

In the housing 110 the main control circuit for the electronic device 100 is disposed. For example, a processing unit (not shown) can be located within the housing 110 for controlling the operation of the electronic device 100. A user command input module 112 can be located on the housing 110 for inputting user control signals to the processing unit. A supplementary display monitor 114 (e.g. an Organic Light Emitting Display, OLED) can also be placed on the housing 110 for providing specific affiliated functions (e.g. caller display interface or music media display interface) of the electronic device 100 when the display monitor 120 is lodged within the housing 110.

Please refer to FIG. 4 and FIG. 5. As described above, in the preferred embodiment the display monitor 120 is capable of sliding into the cavity 150 by means of the support module 130 moving along the track 140. In the closed position, the display monitor 120 is protected within the housing 110 of the electronic device 100. Furthermore, users are able to extend the display monitor 120 outside of the housing 110 by sliding it along the track 140 through pulling the ring handle 122. This achieves an open position that allows the display monitor 120 to display to thereby make the electronic device 100 perform its functionality completely. Moreover, users are able to insert the display monitor 120 back into the housing 110 and turn off the power of the display monitor 120 if not required for specific functions of the electronic device 100. These specific functions can include call display, music media display, or digital camera use. These are some of the functions that can have its operational interface displayed on the supplemental monitor 114 of the housing 110. In practice, the supplemental monitor 114 (e.g. an Organic Light Emitting Display, OLED) requires less display area and consumes less power than the main display monitor 120 (e.g. a liquid crystal display monitor). In this way, the electronic device 100 possesses more usable area for the user command input module 112 (e.g. keyboard) on the housing 110 of the electronic device 100, and also provides reduced power consumption.

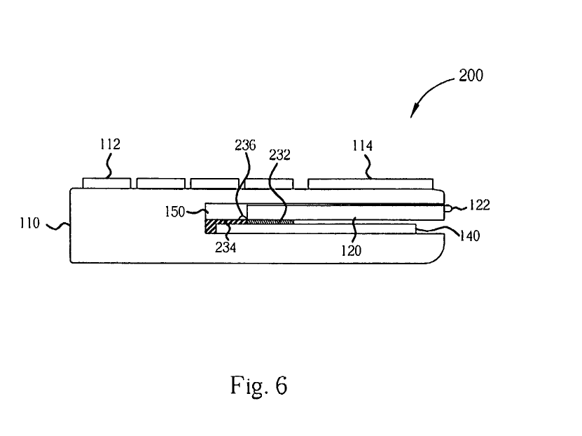

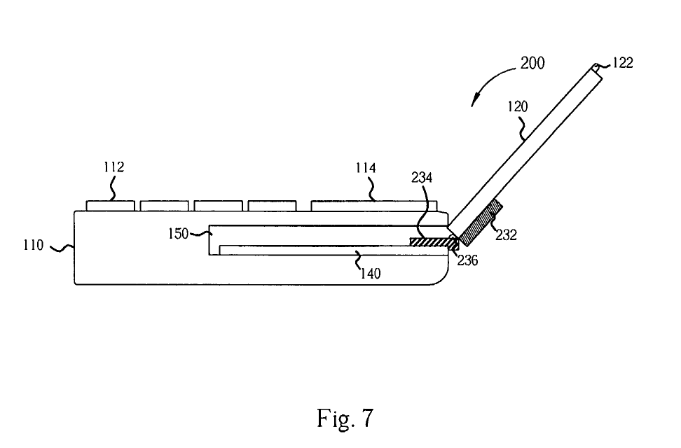

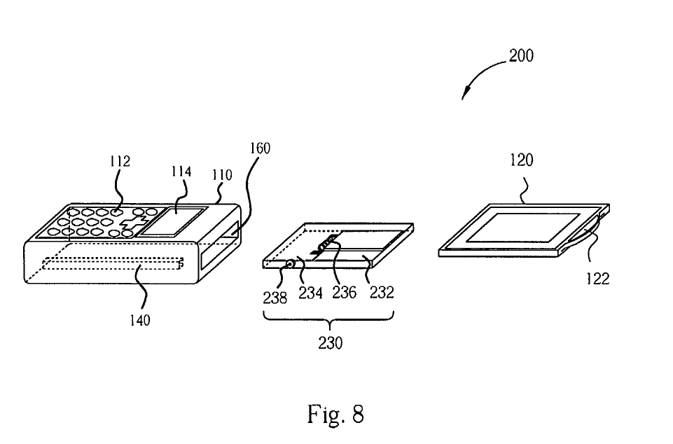

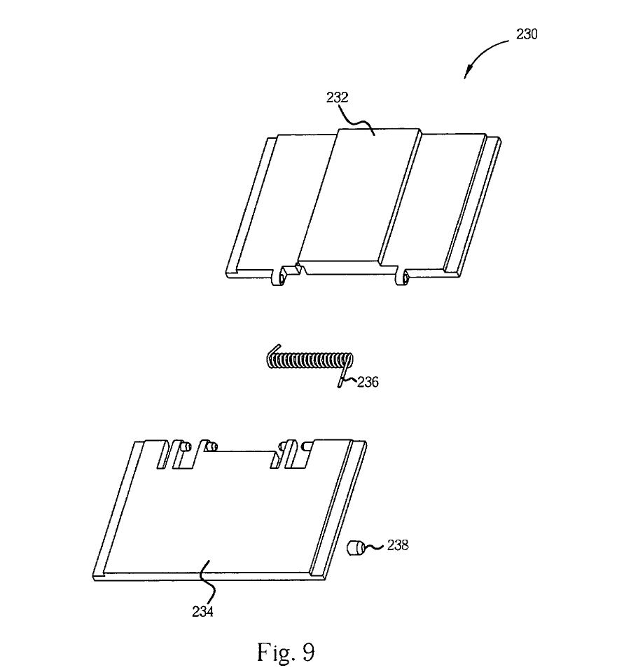

The following description makes reference from FIGS. 6 to FIG. 9. FIG. 6 is a cross-sectional view of the display monitor 120 of the electronic device 200 in a closed position according to a second embodiment of the present invention. FIG. 7 is a cross-sectional diagram illustrating the display monitor 120 in an operating mode according to the electronic device 200 as shown in FIG. 6. FIG. 8 is an assembly diagram illustrating the components of the electronic device 200 as shown in FIG. 6. FIG. 9 is an assembly diagram illustrating the components of the support module 230 as shown in FIG. 6. Please note that components having the same name in the electronic device 200 shown in FIG. 6 and the electronic device 100 shown in FIG. 1 possess the same function and operation. As such, a detailed description is omitted for the sake of brevity. The basic structure of the electronic device 200 of FIG. 6 is similar to the structure of the electronic device 100 of FIG. 1. The main difference between the first and second embodiments is that the support module 230 in the second preferred embodiment includes a first supportive component 232, a second supportive component 234, an elastic element 236 (e.g. a spring) and a pulley 238.

Please note that, in this preferred embodiment, the support module 230 is not limited to having a pulley 238. In other embodiments, a support module without having any pulleys is also adoptable. For instance, the support module 230 can move into the housing 110 by utilizing gear wheels. This alternative design also belongs to the claimed invention. Without affecting the disclosure of the present invention, only one track 140 is shown in FIG. 8, while the support module 230 contains only a single pulley 238 on one side. However, in other embodiments, the housing 110 can include tracks on both sides, and the support module 230 can also include multiple pulleys on both sides to help stabilize the sliding movement. In other words, the present invention is not limited to the number of tracks or pulleys presented. Additionally, the shapes, structures, and locations of the track 140 and the pulley 238 shown in FIG. 8 are utilized only for exemplary purposes and should not be regarded as limitations of the present invention.

As shown through FIGS. 6 to FIG. 9, the first supportive component 232 is coupled to the display monitor 120 for carrying and fasting the display monitor 120. The second supportive component 234 is coupled to the track 140 and is utilizing to move the support module 230 along the track 140 for inserting the display monitor 120 into the cavity 150, or exposing the display monitor 120 outside of the housing 110 through the opening 160. The elastic element 236 is coupled between the first supportive component 232 and the second supportive component 234. When the display monitor 120 is extended outside of the housing 110 through the opening 160, the elastic element 236 provides a retracting force to the first supportive component 232 to adjust the displaying angle of the display monitor 120. In other words, as shown in FIG. 7, when the display monitor 120 slides along the track 140 and is exposed outside the housing 110, the display monitor 120 is elevated by the elastic element 236 while being fixed to the first supportive component 232, where the display monitor 120 is adjusted to a specific displaying angle to therefore provide an optimized viewing angle for its users.

In contrast to the related art, the display monitor of the present invention can move on a track by means of a support module, and can be inserted within the housing to protect the monitor surface. Moreover, since power for the display monitor can be shut down while the display module is inserted into the housing, and a supplementary display monitor can be utilized for the operational interface display of affiliated functions (e.g. caller display, music media display, or digital camera use) for the electronics device. This thereby helps reduce power consumption. Additionally, because the main display monitor is not located directly on the housing surface, the available surface area for user command input module (e.g. keyboard) is increased. Finally, possible inconveniences caused by a bad viewing angle for a conventional electronic devices (e.g. cellular phone) can be solved through raising the display angle of the display monitor as described in the present invention. Overall convenience, and flexibility in ergonomic design for an operational interface is therefore greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a housing containing a cavity, wherein an opening corresponding to the cavity is located on a surface of the housing;
a first display monitor; and
a support module having a first portion for carrying and sliding the first display monitor, and a second portion coupled to the cavity.

2. The electronic device of claim 1, wherein the housing comprises a track coupled to the support module.

3. The electronic device of claim 2, wherein the support module comprises a pulley coupled to the track.

4. The electronic device of claim 1, wherein the support module comprises:
a first supportive component coupled to the first display monitor;
a second supportive component; and
an elastic element coupled to the first and second supportive components, the elastic element for providing a retracting force to the first supportive component to adjust a displaying angle of the first display monitor when the first display monitor is extended outside of the housing through the opening.

5. The electronic device of claim 4, wherein the support module further comprises:
a track coupled to the support module; and
at least a pulley coupled to the second supportive component and positioned in the track for sliding the second supportive component along the track.

6. The electronic device of claim 4, wherein the elastic element is a spring.

7. The electronic device of claim 4, wherein the housing and the support module are coupled by a gear wheel.

8. The electronic device of claim 1, wherein the first display monitor is a liquid crystal display (LCD).

9. The electronic device of claim 1, wherein the housing comprises:
a user command input module disposed on the surface of the housing.

10. The electronic device of claim 1, wherein the housing comprises:
a second display monitor disposed on the surface of the housing;
wherein the second display monitor is an organic light emitting display (OLED).

11. An electronic device, comprising:
a housing containing a cavity, wherein an opening corresponding to the cavity is located on a surface of the housing;
a first display monitor; and
a support module having a first portion for carrying and moving the first display monitor, and a second portion coupled to the cavity, the support module comprising:
a first supportive component coupled to the first display monitor;
a second supportive component; and
an elastic element coupled to the first and second supportive components, the elastic element for providing a retracting force to the first supportive component to adjust a displaying angle of the first display monitor when the first display monitor is extended outside of the housing through the opening.

12. The electronic device of claim 11, wherein the elastic element is a spring.

13. The electronic device of claim 11, wherein the support module further comprises:
a track coupled to the support module; and
at least a pulley coupled to the second supportive component and positioned in the track for sliding the second supportive component along the track.

14. The electronic device of claim 11, wherein the housing and the support module are coupled by a gear wheel.

15. The electronic device of claim 11, wherein the first displaying monitor is a liquid crystal display (LCD).

16. The electronic device of claim 11, wherein the housing comprises:
a user command input module disposed on the surface of the housing.

17. The electronic device of claim 11, wherein the housing comprises:
a second display monitor disposed on the surface of the housing;
wherein the second display monitor is an organic light emitting display (OLED).
